(19) United States
(12) Patent Application Publication
(10) Pub. No.: US 2011/0274861 A1
(43) Pub. Date: Nov. 10, 2011

(54) FUEL MANAGEMENT SYSTEMS HAVING A FLUORORUBBER COMPONENT IN CONTACT WITH FUEL

(75) Inventor: Ronald D. Stevens, Norton, OH (US)

(73) Assignee: DUPONT PERFORMANCE ELASTOMERS LLC, WILMINGTON, DE (US)

(21) Appl. No.: 12/941,321

(22) Filed: Nov. 8, 2010

Related U.S. Application Data
(60) Provisional application No. 61/265,773, filed on Dec. 2, 2009.

(51) Int. Cl. B32B 1/08; C08L 27/20; H01B 1/24; C08L 27/18

(52) U.S. Cl. 428/36.91; 525/199; 525/200; 252/511; 428/36.9

(57) ABSTRACT

Disclosed herein is a fuel management system having at least one fluororubber component in contact with fuel wherein said fluororubber component comprises i) a cured fluoroelastomer and ii) 10 to 110 parts by weight of a non-fibrillating polytetrafluoroethylene micropowder per hundred parts by weight fluoroelastomer.

### CROSS-REFERENCE TO RELATED APPLICATIONS

This application claims the benefit of U.S. Provisional Application No. 61/265,773 filed Dec. 2, 2009.

### FIELD OF THE INVENTION

This invention relates to fuel management systems having a fluororubber component in contact with fuel wherein said fluororubber component comprises i) a cured fluoroelastomer and ii) 10 to 110 parts by weight of a non-fibrillating polytetrafluoroethylene micropowder per hundred parts by weight fluoroelastomer.

### BACKGROUND OF THE INVENTION

Fluoroelastomers having excellent heat resistance, oil resistance, and chemical resistance have been used widely for sealing materials, containers and hoses. Examples of fluoroelastomers include copolymers comprising units of vinylidene fluoride (VF₂) and units of at least one other copolymerizable fluorine-containing monomer such as hexafluoropropylene (HFP), tetrafluoroethylene (TFE), chlorotrifluoroethylene (CTFE), vinyl fluoride (VF), and a fluorovinyl ether such as a perfluoro(alkyl vinyl ether) (PAVE). Specific examples of PAVE include perfluoro(methyl vinyl ether), perfluoro(ethyl vinyl ether) and perfluoro(propyl vinyl ether). Other examples of fluoroelastomers include copolymers comprising tetrafluoroethylene and a perfluoro(alkyl vinyl ether) such as perfluoro(methyl vinyl ether) (PMVE) and copolymers comprising tetrafluoroethylene and a hydrocarbon olefin such as propylene or ethylene.

In order to develop the physical properties necessary for most end use applications, fluoroelastomers must be crosslinked (i.e. ‘cured’). Preferred curing systems include 1) the combination of an organic peroxide and a multifunctional unsaturated coagent and 2) the combination of a polyhydroxy curative (e.g. bisphenol AF) with an inorganic acid acceptor and an accelerator (e.g. a quaternary ammonium salt).

Crosslinked fluoroelastomer articles have been employed in fuel management systems as the fluororubber components that are in contact with fuel, because of the low fuel permeability of fluoroelastomers. See for example U.S. Pat. No. 5,427,831. However, for some end uses, further reduction in fuel permeability is desirable.

Loading the fluororubber component with fillers such as carbon black or mineral fillers is a common method of reinforcing the substrate, but as the level of filler increases, the modulus and stiffness of the substrate increases to a point where the substrate is no longer useful as it has lost its flexibility and softness for sealing and flexing without cracking. It is also known that while loading fluororubber with carbon black can modestly reduce fuel permeation, platy mineral fillers such as talc can significantly reduce fuel permeation, but at the same time significantly increase the hardness, modulus, and stiffness of the component.

Loading a fibrillating polytetrafluoroethylene micropowder, such as Zonyl® MP1500, into fluoroelastomer has been done and is discussed in the literature. When doing this the modulus, hardness, and tensile of the FKM compound increases quickly, and processability suffers, with even a small amount, thus fibrillating PTFE micropowder is not useful when trying to incorporate at a high level.

Non-fibrillating PTFE micropowders have also been employed in fluororubber components (e.g. U.S. Pat. No. 5,461,107) for the purpose of increasing the components' resistance to harsh chemicals such as acids and amines.

### SUMMARY OF THE INVENTION

The present invention provides a fuel management system having at least one fluororubber component in contact with fuel wherein said fluororubber component has excellent (i.e. low) fuel permeability.

One aspect of the present invention is in a fuel management system having at least one fluororubber component in contact with fuel, the improvement wherein said fluororubber component comprises i) a cured fluoroelastomer and ii) 10 to 110 parts by weight of a non-fibrillating polytetrafluoroethylene micropowder per hundred parts by weight fluoroelastomer.

### DETAILED DESCRIPTION OF THE INVENTION

The present invention is directed to fuel management systems having at least one fluororubber component in contact with fuel. The fluororubber component comprises a cured fluoroelastomer and 10 to 110 (preferably 25 to 90, most preferably 25 to 75) parts by weight of a non-fibrillating polytetrafluoroethylene (PTFE) micropowder per hundred parts by weight fluoroelastomer. Such fluororubber components have surprisingly lower fuel permeation than comparable components absent the non-fibrillating PTFE micropowder while maintaining a desirably low modulus (i.e. M₂₅ less than 5 MPa, preferably less than 4.5 MPa).

By the term “fuel management system” is meant equipment employed in the manufacture, storage, transportation and supply, metering and control of fuel. Fuel management systems include those contained in fuel manufacturing plants, motor vehicles (e.g. trucks, cars, boats), stationary fuel powered devices (e.g. electrical generators, portable pumping stations) and those associated with fuel transportation, storage and dispensing. Specific elements of fuel management systems include, but are not limited to fuel tanks, filler neck hoses, fuel tank cap seals, fuel line hoses and tubing, valves, diaphragms and fuel injector components, o-rings, seals and gaskets. Any or all of these elements may comprise one or more fluororubber component that contacts fuel.

By “fuel” is meant hydrocarbon fuels including gasoline, gasoline/alcohol blends, diesel fuel, jet fuels; and biodiesel fuels.

Fluororubber components of this invention include, but are not limited to seals, gaskets, o-rings, tubing, the fuel contact layer of multilayer hoses, valve packings, diaphragms, and tank liners.

The fluoroelastomers employed in this invention comprise copolymerized units of vinylidene fluoride (VF₂) or tetrafluoroethylene (TFE) and one or more additional and different monomer such as a monomer selected from the group consisting of fluorine-containing olefins, fluorine-containing ethers, hydrocarbon olefins and mixtures thereof.

According to the present invention, fluorine-containing olefins include, but are not limited to vinylidene fluoride, hexafluoropropylene (HFP), tetrafluoroethylene, 1,2,3,3,3-pentafluoropropene (1-HPFP), chlorotrifluoroethylene (CTFE) and vinyl fluoride.

The fluorine-containing ethers that may be employed in the fluoroelastomers include, but are not limited to perfluoro(alkyl vinyl ethers), perfluoro(alkyl alkenyl ethers) and perfluoro(alkoxy alkenylethers).

Perfluoro(alkyl vinyl ethers) (PAVE) suitable for use as monomers include those of the formula

CF₂═CFO(R_{f′}O)ₙ(R_{f″}O)ₘR_{f} (I)

where R_{f′} and R_{f″}are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl ethers) includes compositions of the formula

CF₂═CFO(CF₂CFXO)ₙR_{f} (II)

where X is F or CF₃, n is 0-5, and R_{f} is a perfluoroalkyl group of 1-6 carbon atoms. A most preferred class of perfluoro(alkyl vinyl ethers) includes those ethers wherein n is 0 or 1 and R_{f} contains 1-3 carbon atoms. Examples of such perfluorinated ethers include perfluoro(methyl vinyl ether) (PMVE) and perfluoro(propyl vinyl ether) (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms,
m=0 or 1, n=0-5, and Z═F or CF₃. Preferred members of this class are those in which R_{f} is C₃F₇, m=0, and n=1.

Additional perfluoro(alkyl vinyl ether) monomers include compounds of the formula

CF₂═CFO[(CF₂CF{CF₃}O)ₙ(CF₂CF₂CF₂O)ₘ(CF₂)ₚ]CₓF₂ₓ₊₁

### (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

Perfluoro(alkyl alkenyl ethers) suitable for use as monomers include those of the formula VI

R_{f}O(CF₂)ₙCF═CF₂ (VI)

where R_{f} is a perfluorinated linear or branched aliphatic group containing 1-20, preferably 1-10, and most preferably 1-4 carbon atoms and n is an integer between 1 and 4. Specific examples include, but are not limited to perfluoro(propoxyallyl ether) and perfluoro(propoxybutenyl ether).

Perfluoro(alkoxy alkenyl ethers) differ from perfluoro(alkyl alkenyl ethers) in that R_{f} in formula VI contains at least one oxygen atom in the aliphatic chain. A specific example includes, but is not limited to perfluoro(methoxyethoxyallyl ether).

If copolymerized units of a fluorine-containing ether are present in the fluoroelastomers of the invention, the ether unit content generally ranges from 25 to 75 weight percent, based on the total weight of the fluoroelastomer. If perfluoro(methyl vinyl) ether is used, then the fluoroelastomer preferably contains between 30 and 55 wt. % copolymerized PMVE units.

Hydrocarbon olefins that may be contained in the fluoroelastomers include, but are not limited to ethylene and propylene. If copolymerized units of a hydrocarbon olefin are present in the fluoroelastomers, hydrocarbon olefin content is generally 4 to 30 weight percent.

The fluoroelastomers employed in the present invention may also, optionally, comprise units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrite group; vi) fluorine-containing vinyl ethers having a nitrile group; vii) 1,1,3,3,3-pentafluoropropene (2-HPFP); viii) perfluoro(2-phenoxypropyl vinyl) ether; and ix) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}-O—CF═CF₂ (R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1(ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.

CF₂═CF—O(CF₂)ₙ-CN (VII)

where n=2-12, preferably 2-6;

CF₂═CF—O[CF₂—CF(CF₃)—O]ₙ-CF₂—CF(CF₃)—CN (VIII)

where n=0-4, preferably 0-2;

CF₂═CF—[OCF₂CF(CF₃)]ₓ-O—(CF₂)ₙ-CN (IX)

where x=1-2, and n=1-4; and

CF₂═CF—O—(CF₂)—O—CF(CF₃)CN (X)

where n=2-4. Those of formula (IX) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (XI)

i.e. perfluoro(8-cyano-5-methyl-3,6-dioxa-1-octene) or 8-CNVE. Nitrile-containing cure site monomers are particularly useful in copolymers also containing tetrafluoroethylene and perfluoro(methyl vinyl ether).

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred monomers for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. When the fluoroelastomer will be cured with a polyol, 2-HPFP or perfluoro(2-phenoxypropyl vinyl) ether is the preferred cure site monomer.

When the fluoroelastomer will be cured with a tetraamine, bis(aminophenol), bis(thioaminophenol), or a compound (e.g. urea) that decomposes to release ammonia at curing temperatures, 8-CNVE is the preferred cure site monomer.

Units of cure site monomer, when present in the fluoroelastomers employed in this invention, are typically present at a level of 0.05-10 wt. % (based on the total weight of fluoroelastomer), preferably 0.05-5 wt. % and most preferably between 0.05 and 3 wt. %.

Additionally, iodine-containing endgroups, bromine-containing endgroups or nitrile group containing endgroups may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine, bromine or nitrile group level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Two preferred peroxide curable fluoroelastomers that may be employed in this invention comprise copolymerized units of A) vinylidene fluoride, hexafluoropropylene and tetrafluoroethylene and B) vinylidene fluoride, perfluoro(methyl vinyl ether) and tetrafluoroethylene. Each of the latter fluoroelastomers also contain cure sites of bromine atoms, iodine atoms, or both bromine and iodine atoms.

The non-fibrillating polytetrafluoroethylene micropowder that may be employed in this invention has a relatively low number average molecular weight (i.e. 50,000 to 500,000), is friable and has an average agglomerate size of about 4 to 18 μm. By “non-fibrillating” is meant that the PTFE micropowder remains in particulate form and does not fibrillate under typical processing conditions (e.g. mixing, extruding, molding, etc.). Suitable micropowders include Zonyl® MP1600, Zonyl® TE5069AN, Zonyl® TE3950 and Zonyl® MP1000 (available from DuPont). MP1600 is preferred.

The fluoroelastomer, curative, non-fibrillating PTFE micropowder and any other ingredients (e.g. carbon black, conductive carbon black, etc.) are generally incorporated into curable compositions by means of an internal mixer or rubber mill. Mixing is performed at a temperature below the melting point of the PTFE micropowder. Preferably the PTFE micropowder is added to the curable composition in the form of a concentrated masterbatch (about 50 wt % PTFE) in fluoroelastomer. The resulting composition may then be shaped (e.g. molded or extruded) and cured to form fluororubber components. Curing typically takes place at about 150°-200° C. for 1 to 60 minutes. Conventional rubber curing presses, molds, extruders, and the like provided with suitable heating and curing means can be used. Also, for optimum physical properties and dimensional stability, it is preferred to carry out a post curing operation wherein the molded or extruded fluororubber component is heated in an oven or the like for an additional period of about 1-48 hours, typically from about 180°-275° C., generally in an air atmosphere.

### EXAMPLES

### Test Methods

### Tensile Properties

The following physical property parameters were recorded; test methods are in parentheses:

T_{b}: tensile strength, MPa (ASTM D412-92)

E_{b}: elongation at break, % (ASTM D412-92)

M₂₅: modulus at 25% elongation, MPa (ASTM D412-92).

Hardness, Shore A (ASTM D412-92)

Compression Set B (ASTM D395)

Fuel Permeation, g-mm/m²/day, at 40° C. (SAEJ2665 “Test Procedure to Measure the Fuel Permeability of Materials by the Cup Weight Loss Method”)

The invention is further illustrated by, but is not limited to, the following examples.

Fluoroelastomers employed in the examples are commercially available from DuPont Performance Elastomers. FKM1 is Viton® GF-200S, peroxide curable elastomer. FKM2 is Viton® VTR-7551, a bisphenol AF curable fluoroelastomer. FKM3 is Viton® GBL-600S and FKM4 is Viton® GF-600S, both peroxide curable elastomers.

### EXAMPLES 1-2 AND COMPARATIVE EXAMPLES A-E

Peroxide curable compositions for Examples 1-2 and Comparative Examples A-E were made by compounding the ingredients in an internal laboratory mixer and sheet off mill. Formulations are shown in Table I.

The compositions were molded into slabs and press cured at 162° C. for 30 minutes. O-rings for compression set resistance testing were molded and cured in the same manner as the slabs. Tensile properties were measured according to the Test Methods and are also shown in Table I.

30 mil (0.76 mm) diaphragms, made by the same process as the above slabs, were exposed to CE-10 fuel (90% ASTM Fuel C/10% Ethanol) or to CM-15 fuel (85% Fuel C/15% Methanol) for 672 hours. Fuel permeation was measured according to the Test Method and results are reported in Table I.

The 25% modulus (stiffness) and physical properties of Examples 1 and 2 of the invention are similar to that of Comparative Examples B and C which are filled with carbon black at typical levels. However, the fuel permeation of Examples 1 and 2 is much better (i.e. lower), approaching that of the talc filled, very stiff Comparative Example E which has a high 25% modulus of 9.1 MPa.

TABLE I

| | Comp. | Comp. | Comp. | Comp. | Comp. | Example | Example |
|---|---|---|---|---|---|---|---|
| | Ex. A | Ex. B | Ex. C | Ex. D | Ex. E | 1 | 2 |
| Ingredient, Phr¹ | | | | | | | |
| FKM1 | 100 | 100 | 100 | 100 | 100 | 100 | 100 |
| Struktol ® HT-290² | 0.5 | 0.5 | 0.5 | 0.5 | 0.5 | 0.5 | 0.5 |
| Carbon Black N990 | 5 | 35 | 75 | 5 | 5 | 5 | 5 |
| Mistron Vapor³ | 0 | 0 | 0 | 30 | 70 | 0 | 0 |
| Zonyl ® MP-1600 | 0 | 0 | 0 | 0 | 0 | 30 | 70 |
| Coagent⁴ | 2.2 | 2.2 | 2.2 | 2.2 | 2.2 | 2.2 | 2.2 |
| Peroxide⁵ | 2 | 2 | 2 | 2 | 2 | 2 | 2 |
| Physical Properties | | | | | | | |
| M₂₅, MPa | 0.75 | 1.5 | 3.6 | 4.1 | 9.1 | 1.6 | 3.4 |
| T_{b}, MPa | 11.6 | 8.9 | 10.4 | 13.0 | 12.3 | 12.6 | 10.3 |
| E_{b}, % | 356 | 281 | 138 | 284 | 136 | 346 | 320 |
| Hardness, A, points | 55 | 73 | 89 | 79 | 90 | 69 | 82 |
| Compression Set, | 9 | 9 | 10 | 30 | 51 | 14 | 23 |
| 70 hours @100° C., % | | | | | | | |
| Fuel Permeation | | | | | | | |
| CE-10 | 22.9 | 21.5 | 21.3 | 10.2 | 4.7 | 13.5 | 7.2 |
| CM-15 | 46.7 | 42.5 | 38.5 | 21.4 | 11.7 | 28.1 | 15.9 |

¹parts by weight ingredient per 100 parts by weight rubber (i.e. fluoroelastomer)
²HT290 available from Struktol Inc.
³talc available from LUZENAC AMERICA INC. as Mistron Vapor
⁴Diak 7 triallyl isocyanurate available from R. T. Vanderbilt
⁵Varox ® DBPH-50 available from R. T. Vanderbilt

### EXAMPLES 3-4 AND COMPARATIVE EXAMPLE F

Bisphenol curable compositions for Examples 3-6 and Comparative Example F were made by compounding the ingredients in an internal laboratory mixer and sheet off mill. Except in Example 6, PTFE (Zonyl® TE3950) was added to the formulations as a masterbatch (MB) of 50 wt % PTFE in FKM2. Formulations are shown in Table II.

The compositions were molded into slabs and press cured at 162° C. for 25 minutes and postcured for 2 hours at 150° C. in an air circulating oven. O-rings for compression set resistance testing were molded and cured in the same manner as the slabs. Tensile properties were measured according to the Test Methods and are also shown in Table II.

80 mil (2 mm) diaphragms, made by the same process as the above slabs, were exposed to CE-10 fuel (90% ASTM Fuel C/10% Ethanol) for 672 hours. Fuel permeation was measured according to the Test Method and results are reported in Table II.

The 25% modulus (stiffness) and physical properties of bisphenol cured Example 3 of the invention is similar to that of Comparative Example F which is filled with carbon black at a typical level. However, the fuel permeation of Example 3 is better (i.e. lower) than Comparative Example F. In Examples 4 and 5, higher levels of the PTFE masterbatch result in still better (lower) fuel permeation while maintaining a useful 25% modulus value of less than 5.0 MPa. When comparing Examples 4 and 6, which both have a PTFE level of 20 phr, an advantage in tensile strength and lower permeation with the PTFE masterbatch in Example 4 is seen.

TABLE II

| Ingredient, | Comp. | Exam- | | | |
|---|---|---|---|---|---|
| Phr¹ | Ex. F | ple 3 | Example 4 | Example 5 | Example 6 |
| FKM2 | 100 | 90 | 80 | 60 | 100 |
| MB | 0 | 20 | 40 | 80 | 0 |
| Carbon Black | 30 | 25 | 20 | 15 | 20 |
| N990 | | | | | |
| VC50⁶ | 2.5 | 2.5 | 2.5 | 2.5 | 2.5 |
| Zonyl ® TE3950 | 0 | 0 | 0 | 0 | 20 |
| Elastomag 170⁷ | 6 | 6 | 6 | 6 | 6 |
| Ca(OH)₂⁸ | 3 | 3 | 3 | 3 | 3 |
| Carnauba Wax | 0.8 | 0.8 | 0.8 | 0.8 | 0.8 |
| Physical | | | | | |
| Properties | | | | | |
| M₂₅, MPa | 1.8 | 1.9 | 3.1 | 3.0 | 2.4 |
| T_{b}, MPa | 8.8 | 9.3 | 9.7 | 8.5 | 9.0 |
| E_{b}, % | 314 | 344 | 330 | 330 | 346 |
| Hardness, A, | 78 | 74 | 80 | 79 | 77 |
| points | | | | | |
| Compression | 33 | 32 | 37 | 42 | 35 |
| Set, 70 hours | | | | | |
| @100° C., % | | | | | |
| Fuel | | | | | |
| Permeation | | | | | |
| CE-10 | 32.9 | 28.6 | 24.7 | 17.2 | 25.4 |

⁶a salt of bisphenol AF and a quaternary phosphonium salt
⁷MgO available from Akrochem Corp.
⁸HP-XL available from Hallstar Co.

### EXAMPLES 7-8 AND COMPARATIVE EXAMPLES G-H

Peroxide curable compositions for Examples 7-8 and Comparative Examples G-H were made by compounding the ingredients in an internal laboratory mixer and sheet off mill. Formulations are shown in Table III.

The compositions were molded into slabs, press cured at 177° C. for 7 minutes and postcured for 16 hours at 232° C. in an air circulating oven. Tensile properties were measured according to the Test Methods and are also shown in Table III. Glass transition temperature, Tg, was measured by DSC.

30 mil (0.76 mm) diaphragms, made by the same process as the above slabs, were exposed to CE-10 fuel (90% ASTM Fuel C/10% Ethanol) for 672 hours at 40° C. Fuel permeation was measured according to the Test Method and results are reported in Table III.

Comparative Examples G and H show 68% and 70% (respectively) fluorine fluoroelastomer compounds with 70 phr mineral filler. The 70% fluorine Viton® GF-600S compound (Comparative Example H) had better (i.e. lower) fuel permeation, but inferior low temperature properties (i.e. higher Tg) compared to the 68% fluorine Viton® GBL-600S compound (Comparative Example G). In Examples 7 and 8, the mineral filler was replaced with Zonyl® TE5069AN PTFE powder. The physical and low temperature properties of Examples 7 and 8 are similar to that of Comparative Example G. However, the fuel permeation is better (i.e. lower), approaching that of the 70% fluorine. Comparative Example H.

TABLE III

| Ingredient, | | | | |
|---|---|---|---|---|
| Phr¹ | Comp. Ex. G | Example 7 | Example 8 | Comp. Ex. H |
| FKM3 | 100 | 100 | 100 | 0 |
| FKM4 | 0 | 0 | 0 | 100 |
| Struktol ® HT- | 1 | 0 | 0 | 1 |
| 290² | | | | |
| Zinc Oxide | 3 | 3 | 3 | 3 |
| BaSO₄ | 70 | 0 | 0 | 70 |
| Zonyl ® | 0 | 35 | 70 | 0 |
| TE5069AN | | | | |
| PTFE | | | | |
| TiO₂ | 1 | 3 | 3 | 1 |
| Akrochem 414 | 1 | 1 | 1 | 1 |
| Green⁹ | | | | |
| Coagent⁴ | 2.5 | 2.5 | 2.5 | 2.5 |
| Peroxide⁵ | 1.5 | 1.5 | 1.5 | 1.5 |
| Physical | | | | |
| Properties | | | | |
| M₂₅, MPa | 1.4 | 1.3 | 2.2 | 1.7 |
| T_{b}, MPa | 13.3 | 15.2 | 11.5 | 9.6 |
| E_{b}, % | 456 | 466 | 447 | 306 |
| Hardness, A, | 74 | 69 | 77 | 76 |
| points | | | | |
| Tg, ° C. | −20 | −18 | −18 | −9 |
| Fuel | | | | |
| Permeation | | | | |
| CE-10 | 42 | 28 | 18 | 14 |

⁹colorant available from Akrochem Corp.

What is claimed is:

1. In a fuel management system having at least one fluororubber component in contact with fuel, the improvement wherein said fluororubber component comprises i) a cured fluoroelastomer and ii) 10 to 110 parts by weight of a non-fibrillating polytetrafluoroethylene micropowder per hundred parts by weight fluoroelastomer.

2. A fuel management system of claim 1 wherein said non-fibrillating polytetrafluoroethylene micropowder is present in an amount of 25 to 90 parts by weight per hundred parts by weight fluoroelastomer.

3. A fuel management system of claim 2 wherein said non-fibrillating polytetrafluoroethylene micropowder is present in an amount of 25 to 75 parts by weight per hundred parts by weight fluoroelastomer.

4. A fuel management system of claim 1 wherein said non-fibrillating polytetrafluoroethylene micropowder has a number average molecular weight of 50,000 to 500,000 and an average agglomerate size of 4 to 18 μm.

5. A fuel management system of claim 1 wherein said fluororubber component has a modulus at 25% elongation less than 5 MPa.

6. A fuel management system of claim 1 wherein said fluoroelastomer comprises copolymerized units selected from the group consisting of A) vinylidene fluoride, hexafluoropropylene and tetrafluoroethylene and B) vinylidene fluoride, perfluoro(methyl vinyl ether) and tetrafluoroethylene.

7. A fuel management system of claim 1 wherein said fluororubber component further comprises conductive carbon black.

8. A fuel management system of claim 1 wherein said fluororubber component is selected from the group consisting of a seal, gasket, o-ring, tubing, fuel contact layer of a multilayer hose, valve packing, diaphragm and tank liner.
